(19) United States
(12) Patent Application Publication
(10) Pub. No.: US 2021/0043181 A1
(43) Pub. Date: Feb. 11, 2021

(54) Music Loudspeaker of Mobile Phone

(71) Applicant: Hoxon Gakki Corporation, Dalin Township (TW)

(72) Inventor: Kuo-An Lee, Dalin Township (TW)

(21) Appl. No.: 16/532,563

(22) Filed: Aug. 6, 2019

(51) Int. Cl. G10K 11/08; G10K 11/22

(52) U.S. Cl. CPC G10K 11/08; H04M 1/04; G10K 11/22

(57) ABSTRACT

A loudspeaker for music of the mobile phone includes a sound-transmitting tube with a bell mouth closed at one end and on the tube surface, and a retractable and rotatable externally-closed compensating tube inserted into the sound-transmitting tube, and a long groove-shaped corresponding socket at the relative place of the tube surface of the sound-transmitting tube and the compensating tube, and then the angle and position of the compensating tube are rotated and telescoped, so that a open is formed between two sockets of the sound-transmitting tube and the compensating tube for obliquely inserting the mobile phone with the appropriate width and thickness, so that the music sound played out from the bottom of the mobile phone can be more fully played out from the bell mouth via the sound-transmitting tube, and then the volume is larger, and the sound is warmer and richer.

### BACKGROUND OF INVENTION

### 1. Field of the Invention

The present invention relates generally to a sound-transmitting tube with a bell mouth, and a compensating tube is inserted in the sound-transmitting tube, and at the same time, the socket for inserting the mobile phone is provided at the position corresponding to the tube surface of the sound-transmitting tube inserted with the compensating tube, so that the lamination place of two socket conforms to the insertion port of the width and thickness of the mobile phone through the telescoping and angular rotation of the different position of the compensating tube, thereby improving the defect that the sound is leaked from the opening.

### 2. Description of Related Art

Generally, the mobile phones or other handheld mobile devices are provided with the loudspeakers for playing out the sound and music. However, due to space constraints, the miniature loudspeakers are used. Even though the technology is constantly updated, the mobile phone itself can provide a good sound source. But, the quality of the music played out directly by the mobile phone loudspeaker is still not comparable to that of the traditional loudspeaker, and the volume is also limited.

Therefore, the market has continuously introduced the loudspeakers or loudspeaker boxes that are connected to mobile phones in different ways (such as 3.5 mm audio cable, USB or Bluetooth), so that the mobile phone can play out the music with better sound quality through the external loudspeaker, but the sound quality of the music played out by amplified sound is not the sound quality provided by the mobile phone itself, and it is played out through the loudspeaker of the external loudspeaker itself, so it may have lost the good sound quality of the mobile phone itself.

Although there are also external loudspeakers with excellent quality design, their prices are often prohibitive. Also, these electronic external loudspeakers have the power requirements and need to be charged or to install the battery, and the power duration is also shorter, and the market has also developed the power-free mobile phone amplifiers. The main method is to design a loudspeaker with an open side, and a socket for the phone to be inserted on the top surface of the loudspeaker. When the bottom of the phone is inserted into the loudspeaker from the socket, the music played by the loudspeaker at the bottom of the phone can be used to resonate inside the loudspeaker, so that the volume of the music is enlarged and a better sound quality is transmitted.

However, because of the different brands or models of mobile phones, the width and thickness will be different, and the length and width of the sockets of the above-mentioned loudspeakers will be designed to be suitable for various mobile phones with larger length and width, which causes most of the mobile phones to be inserted into the sockets of the loudspeakers, there will be a considerable distance between the front and rear and the left and right sides, causing the sound of the mobile phone leaked directly from the sockets, so that the sound source can not be completely reflected and resonated in the loudspeaker, resulting in the sound quality played by the loudspeaker can not achieve the expected good effects.

### SUMMARY OF THE INVENTION

In order to improve the partial sound of the mobile phone to be amplified by the loudspeaker, which will be leaked out from the insertion port of the mobile phone, and the sound cannot be completely reflected and resonated in the loudspeaker. Therefore, the present invention provides an externally-closed compensating tube at the open end of the sound-transmitting tube with the amplification resonance bell mouth, and tube surface of the sound-transmitting tube is provided with a corresponding socket opposite to the compensating tube, and an appropriate insertion port is formed between two sockets appropriate to the width and thickness of the mobile phone through the telescoping and rotation of the compensating tube, so that the opening and the mobile phone are more closed to prevent leakage of sound, thereby achieving a more complete reflection and resonance of the music of the mobile phone, and the volume played out by the bell mouth is larger, and the sound is warmer and richer.

The technical solution adopted by the present invention to solve the technical problem is as follows: a bell mouth arranged on the sound-transmitting tube closed at one end, a socket opened on the tube surface of the sound-transmitting, a retractable and rotatable externally-closed compensating tube inserted into the sound-transmitting tube, and a socket corresponding to the socket of the sound-transmitting tube opened on the tube surface of the compensating tube.

In the above solution, a through hole is opened in the outside end surface of the compensating tube. In the above solution, an obliquely rearward supporting leg is provided at the back of the sound-transmitting tube.

Therefore, two sockets are opened corresponding to the tube surface of the sound-transmitting tube and the compensating tube of the above-mentioned loudspeaker of the present invention, a more closed insertion port suitable to width and thicker of the mobile phone is formed by the telescoping and angular rotation of the compensating tube, not only it can provide a more stable insertion for the mobile phone, but also prevent the mobile phone music leaked out from the insertion port, so that the music can be more completely reflected and resonated from the bell mouth.

### BRIEF DESCRIPTION OF THE DRAWINGS

The present invention will be further described below in conjunction with the attached drawings and embodiments.

FIG. 1 is a three-dimensional schematic diagram of the loudspeaker of the present invention.

FIG. 2 is a front three-dimensional decomposition schematic diagram of the loudspeaker of the present invention.

FIG. 3 is a rear three-dimensional decomposition schematic diagram of the loudspeaker of the present invention.

FIG. 4 is a schematic diagram of the loudspeaker of the present invention after adjusting the insertion port of the mobile phone.

FIG. 5 is a schematic diagram of the loudspeaker of the present invention after the mobile phone is inserted in the loudspeaker.

FIG. 6 is a schematic diagram of another embodiment of the loudspeaker adjustment unit of the present invention.

FIG. 7 is a schematic diagram of the use state of the loudspeaker for external loudspeaker amplification of the present invention.

### DETAILED DESCRIPTION OF THE INVENTION

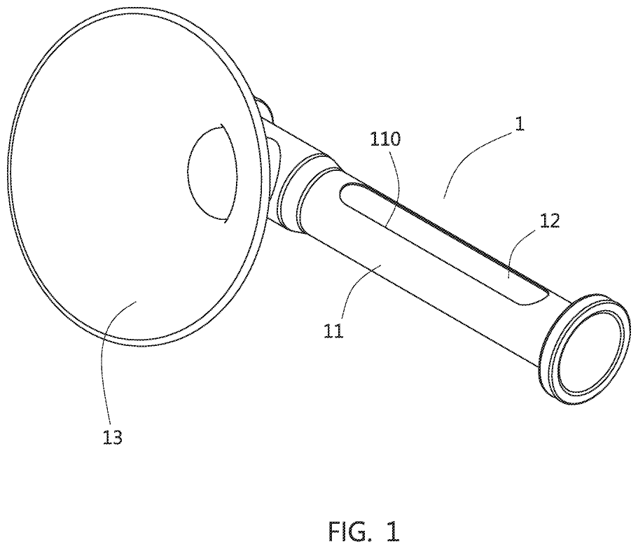

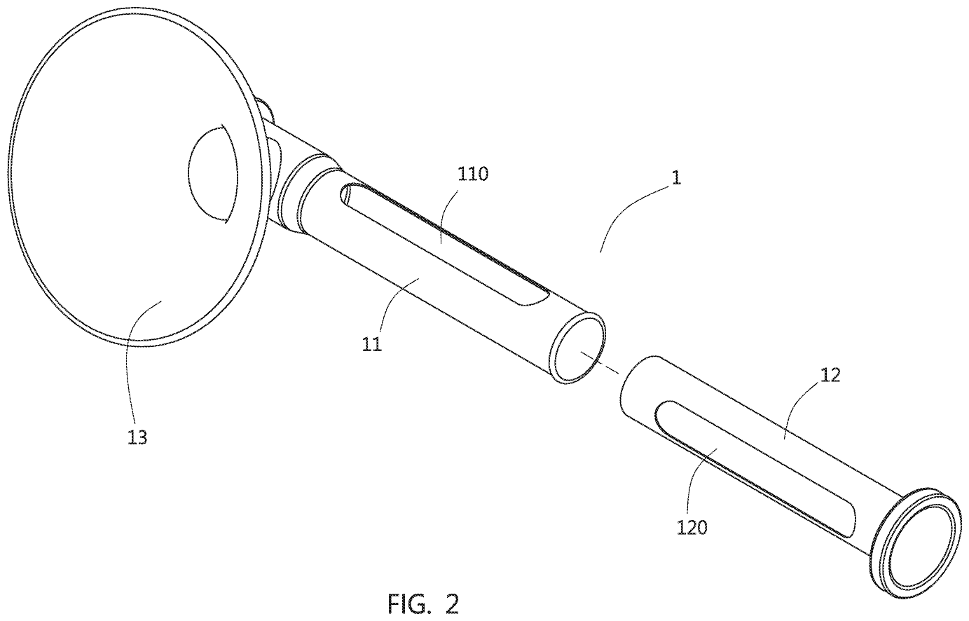

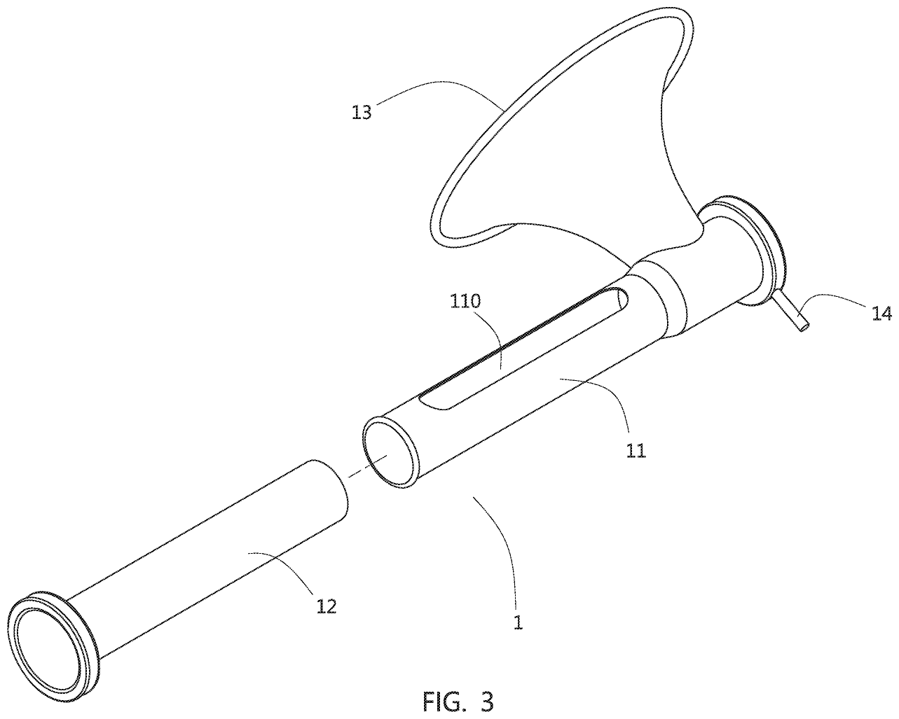

Please refer to FIG. 1 to FIG. 3, the loudspeaker 1 of the present invention is mainly composed of a sound-transmitting tube 11 and a compensating tube 12 which are engaged together, so that the non-engaged end of the sound-transmitting tube 11 is in a closed state, and the sound-transmitting tube 11 is connected with a bell mouth 13 which can reflect and resonate the sound, and the outside of the compensated tube 12 is protruded out from the sound-transmitting tube 11 and is also closed.

Further, two sockets 110 and 120 for inserting the objects are opened at the relative place on the tube surface between the closure of the sound-transmitting tube 11 and the compensating tube 12, and also the compensating tube 12 can be adjusted in the sound-transmitting tube 11 by telescoping and rotation, so that the size of the opening after the overlap between two sockets 110 and 120 can be adjusted.

Also, a support leg 14 is obliquely disposed rearward at the back of the sound-transmitting tube 11, so that the support leg 14 can be supported on the tabletop to prevent the backward rolling of the sound-transmitting tube 11, and the outer lower edge of the above bell mouth 13 is also against the desktop, to prevent the forward-rolling of the sound-transmitting tube 11.

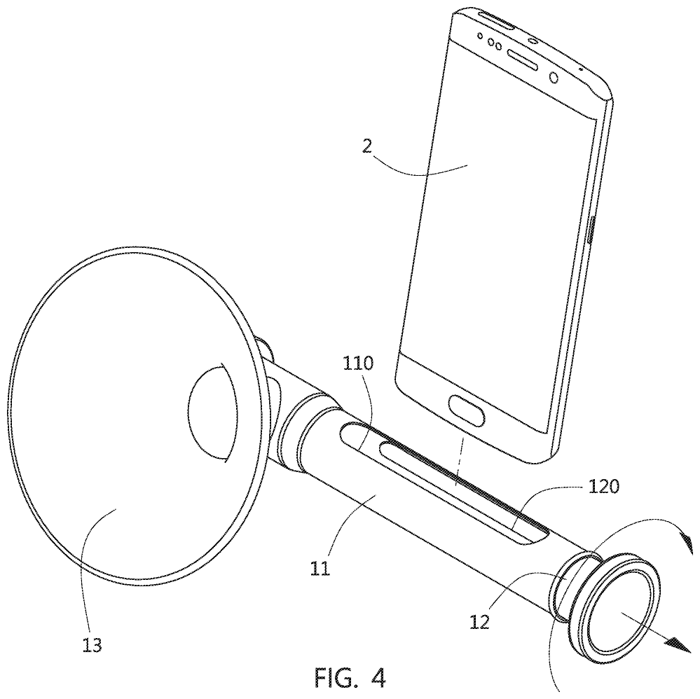

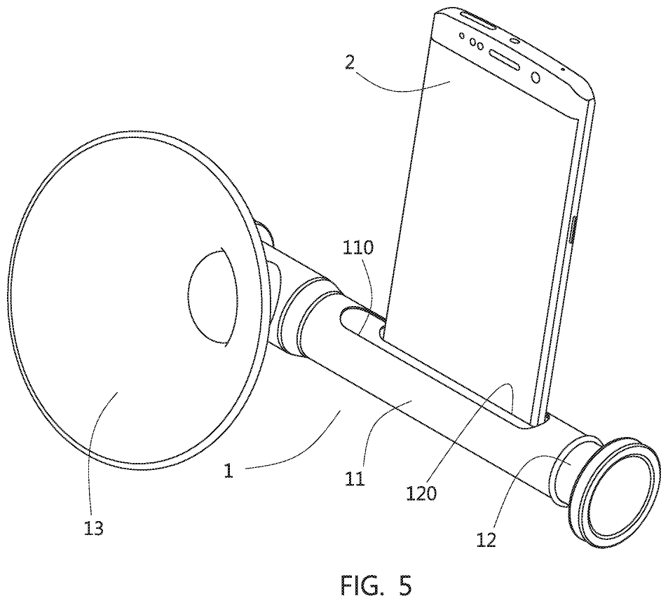

Therefore, as shown in FIG. 4 and FIG. 5, the compensating tube 12 telescoped outward is pulled out, and after rotating at a suitable angle, the open formed by overlap between the socket 110 of the sound-transmitting tube 11 and the socket 120 of the compensated tube 12 can be used to insert the mobile phone 2 with the appropriate corresponding width and thickness, so that the mobile phone 2 is obliquely against the inserted open and the bottom of the compensated tube 12, and the mobile phone 2 can be more stably inserted in the loudspeaker 1.

Also, after the open formed by the overlap between the two sockets 110 and 120 of the sound-transmitting tube 11 and the telescopic tube 12 provides a more close insertion for the mobile phone 2, the music played out from the bottom of the mobile phone 2 is not leaked from the open, so that the sound can be more completely played out by reflection and resonance from the bell mouth 13 via the sound-transmitting tube 11, the music amplification effect of the mobile phone 2 is better, and also the played sound quality is more gentle and rich.

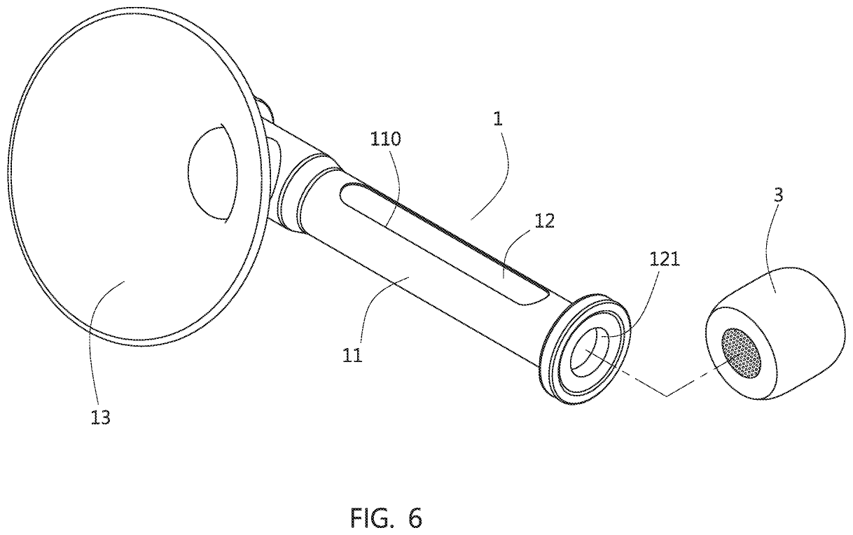

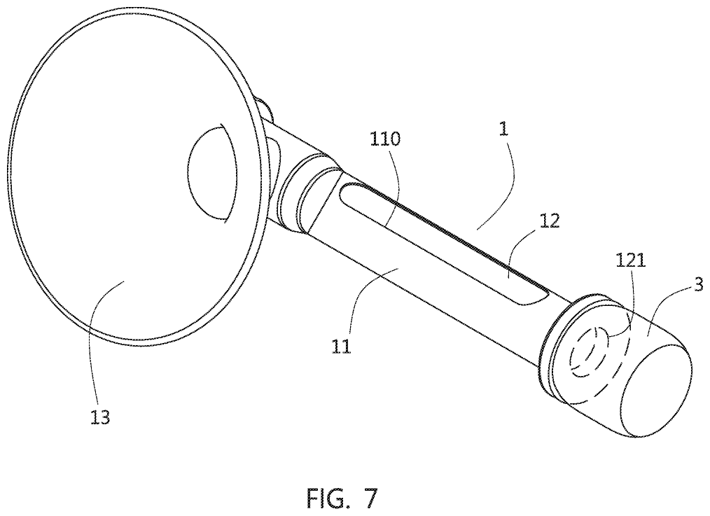

Next, as shown in FIG. 6 and FIG. 7, the outside end of the compensating tube 12 can be provided with a through hole 121, which can also be closed by other components (not shown in the figure), and the compensating tube 12 is rotated, so that the socket 120 on the compensating tube 12 is not overlapped with the socket 110 on the sound-transmitting tube 11 due to staggering, so that a closed tube is formed, thereby providing a sounding end of an external mini loudspeaker 3 to be tightly pressed against the through hole 121 of the compensating tube 12, the sound played by the loudspeaker 3 can be more completely played out by reflection and resonance from the bell mouth 13 via the sound-transmitting tube 11.

1. A loudspeaker for music of the mobile phone includes a bell mouth arranged on a sound-transmitting tube closed at one end, and a socket opened on the tube surface of the sound-transmitting tube, an externally-closed retractable and rotatable compensating tube closely inserted into the sound-transmitting tube, and a socket corresponding to the socket of the sound-transmitting tube opened on the tube surface of the compensating tube.

2. The loudspeaker for music of the mobile phone defined in claim 1, wherein a through hole is opened on the outside end surface of the compensating tube.

3. The loudspeaker for music of the mobile phone defined in claim 1, wherein an obliquely rearward supporting leg is provided at the back of the sound-transmitting tube.
